(19) United States
(12) Patent Application Publication
(10) Pub. No.: US 2011/0016423 A1
(43) Pub. Date: Jan. 20, 2011

(54) GENERATING WIDGETS FOR USE IN A GRAPHICAL USER INTERFACE

(75) Inventor: Jeffrey T. Brubaker, Carrboro, NC (US)

Correspondence Address: PVF -- SYNOPSYS, INC;c/o PARK, VAUGHAN & FLEMING LLP, 2820 FIFTH STREET, DAVIS, CA, 95618-7759, US

(73) Assignee: SYNOPSYS, INC., Mountain View, CA (US)

(21) Appl. No.: 12/610,219

(22) Filed: Oct. 30, 2009

Related U.S. Application Data
(60) Provisional application No. 61/226,157, filed on Jul. 16, 2009.

(51) Int. Cl. G06F 3/048

(52) U.S. Cl. 715/800; 715/788

(57) ABSTRACT

During a technique for generating a window, a description of an object and associated attributes, which include information other than a visual presentation of the object, are received from a user. Then, different types of widgets are generated based at least on the description of the object, the attributes and predefined widget rules. These widgets are arranged in a window based at least on the widgets and predefined layout rules. For example, the widgets may be dynamically resized based on the number of widgets and the size of the window. Then, the window is presented in a graphical user interface (GUI). Subsequently, the window and the attributes are dynamically updated to reflect changes to either one. In this way, the user may focus on the high-level aspects of what is to be presented in the GUI, instead of how to translate this information into the corresponding visual presentation.

### CROSS REFERENCE TO RELATED APPLICATIONS

This application claims priority under 35 U.S.C. 119(e) to U.S. Provisional Application Ser. No. 61/226,157, entitled “GUI Framework,” by Jeffrey Thomas Brubaker, filed on Jul. 16, 2009, attorney docket number SNPS-1241P1, the contents of which are herein incorporated by reference.

### BACKGROUND

1. Field

This disclosure generally relates to a technique for generating a graphical user interface. More specifically, this invention relates to a technique for generating widgets for use in a window in a graphical user interface based on predefined widget rules.

2. Related Art

Graphical user interfaces (GUIs) are widely used in software applications to present information to users, and to receive user inputs. For example, a dialog box or window in a GUI may include multiple fields, which present information and/or which receive user inputs.

However, it is often time-consuming for a user to create a window for use in a GUI. In particular, not only does the user usually need to determine what the window will do (i.e., what information will be presented or received), but the user also has to define the visual presentation of the fields in the window.

This approach can be problematic, especially if the visual presentation is hard coded. Then, if the display size changes or if the user adds another field to the window, the user may need to revise the defined visual presentation.

Furthermore, in software applications that include large, complicated windows, the code associated with the window may be large, and it may be difficult for the user to parse and maintain. In such software applications, it may be necessary for the user to become very knowledgeable about GUIs and how to implement the visual presentation, instead of leveraging the benefits of specialization and ‘outsourcing’ this portion of the software application to a suitable expert. Consequently, implementing and maintaining windows in a GUI can be difficult and time-consuming, which increases the cost of software applications.

### SUMMARY

One embodiment of the present disclosure provides a computer system that presents a window in a graphical user interface (GUI). During operation, the computer system receives a description of an object and associated attributes from a user, where the description of the object and the associated attributes include information other than that associated with a visual presentation of the object (i.e., the user may specify the data model (such as types, restrictions, etc) and very little about the user interface). Note that the description may include restrictions on how the attributes may be manipulated, such as: a restriction on a range of possible values, valid discrete values and/or whether it is read-only. Then, the computer system generates one or more widgets based at least on the description of the object, the associated attributes and predefined widget rules, where the widgets include different types of widgets. Next, the computer system arranges the widgets in the window based at least on the widgets and predefined layout rules, and presents the window in the GUI.

In some embodiments, a given object (such as a data object) has an associated widget builder that determines the appropriate graphical representation for this type of data given system constraints and GUI guidelines. The widget builder may also update the data object based on user input in the GUI or when the data object itself is modified and expresses constraints on the sizing nature of the GUI. Moreover, the window (or the container) may use this information to adjust the layout. Note that both types and widget builders may be added to the computer system without modifying the computer system.

Furthermore, generating the given widget may involve creating a widget controller that is associated with the given widget. This widget controller may dynamically update the associated attributes based at least on changes, in the window, to a subset of the attributes associated with the given widget. Additionally, the widget controller may dynamically update the given widget in the window based at least on changes to one or more of the associated attributes. Note that the dynamic updates may occur after compiling of computer software that includes instructions associated with at least some of the above-described operations. Alternatively or additionally, the dynamic updates may occur during execution of the computer software.

In some embodiments, arranging the widgets in the window involves aligning the widgets in a vertical direction in the window. For example, the widgets may be aligned in one or more columns in the window. Alternatively or additionally, arranging the widgets in the window may involve: determining a horizontal size and a vertical size of the window; and resizing at least some of the widgets based at least on the determined horizontal size and the determined vertical size. Note that determining the horizontal size and the vertical size, and resizing at least some of the widgets may be performed dynamically based on changes to the associated attributes during execution of the computer software, thereby dynamically resizing the window.

Furthermore, the predefined widget rules and the predefined layout rules may be different than the description of the object and the associated attributes. Additionally, the predefined widget rules and the predefined layout rules may not be provided by the user. In this way, the user may focus on the high-level aspects of what is to be presented in the GUI, instead of worrying about how to translate this information into a corresponding visual presentation.

In some embodiments, the generated widgets include predefined function icons if the object is associated with an executable procedure in the computer software. Furthermore, after the user activates one of the function icons, the executable procedure may perform a computation based at least on inputs, associated with the widgets, which are specified or provided by the user using the window.

Note that associated attributes may include constraints on the inputs. Consequently, the computer system may perform a self-check of an input associated with the given widget using one or more of the constraints. If the input violates at least one of the constraints, the computer system may change a visual presentation of the given widget, thereby alerting a user that there is an error condition.

Another embodiment provides a method including at least some of the above-described operations.

Another embodiment provides a computer-program product (such as the computer software) for use in conjunction with the computer system.

Another embodiment provides the GUI, which includes the widgets in the window.

### BRIEF DESCRIPTION OF THE FIGURES

FIG. 1 is a flowchart illustrating various operations in the design and fabrication of an integrated circuit in accordance with an embodiment of the present disclosure.

FIG. 2 is a flowchart illustrating a method for presenting a window in a graphical user interface (GUI) in accordance with an embodiment of the present disclosure.

FIG. 3 is a drawing illustrating attributes associated with an object description of a widget in accordance with an embodiment of the present disclosure.

FIG. 4A is a drawing illustrating a window that includes multiple widgets in accordance with an embodiment of the present disclosure.

FIG. 4B is a drawing illustrating a window that includes multiple widgets in accordance with an embodiment of the present disclosure.

FIG. 5A is a drawing illustrating a window that includes multiple widgets in accordance with an embodiment of the present disclosure.

FIG. 5B is a drawing illustrating a window that includes multiple widgets in accordance with an embodiment of the present disclosure.

FIG. 5C is a drawing illustrating a window that includes multiple widgets in accordance with an embodiment of the present disclosure.

FIG. 5D is a drawing illustrating a window that includes multiple widgets in accordance with an embodiment of the present disclosure.

FIG. 6 is a drawing illustrating a window that includes multiple widgets in accordance with an embodiment of the present disclosure.

FIG. 7 is a drawing illustrating a window that includes multiple widgets in accordance with an embodiment of the present disclosure.

FIG. 8 is a block diagram illustrating a computer system that performs the method of FIG. 2 in accordance with an embodiment of the present disclosure.

FIG. 9 is a block diagram illustrating a data structure for use in conjunction with the computer system of FIG. 8 in accordance with an embodiment of the present disclosure.

Table 1 provides pseudo-code in accordance with an embodiment of the present disclosure.

Table 2 provides pseudo-code in accordance with an embodiment of the present disclosure.

Table 3 provides pseudo-code in accordance with an embodiment of the present disclosure.

Table 4 provides pseudo-code in accordance with an embodiment of the present disclosure.

Table 5 provides pseudo-code in accordance with an embodiment of the present disclosure.

Note that like reference numerals refer to corresponding parts throughout the drawings. Moreover, multiple instances of the same type of part are designated by a common prefix separated from an instance number by a dash.

### DETAILED DESCRIPTION

The following description is presented to enable any person skilled in the art to make and use the disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not intended to be limited to the embodiments shown, but is to be accorded the widest scope consistent with the principles and features disclosed herein.

Embodiments of a computer system, a method, and a computer-program product (i.e., software) for use with the computer system are described. During the method, a description of an object and associated attributes are received from a user. This description and the associated attributes include information other than that associated with a visual presentation of the object (i.e., the user may specify the data model, such as types, restrictions, etc., and very little about the user interface). Then, different types of widgets are generated based at least on the description of the object, the associated attributes and predefined widget rules. These widgets are arranged in a window based at least on the widgets and predefined layout rules. For example, the widgets may be dynamically resized based on the number of widgets and the size of the window. Then, the window is presented in the graphical user interface (GUI). Subsequently, the window may be dynamically updated to reflect changes to the associated attributes, and the associated attributes may be dynamically updated to reflect changes to the widgets. In this way, the user may focus on the high-level aspects of what is to be presented in the GUI, instead of worrying about how to translate this information into a corresponding visual presentation.

By providing an efficient division of labor for the user, this technique for generating widgets may reduce the time and effort needed to develop and/or to maintain software applications. Therefore, this technique may reduce the cost of the software applications.

In the discussion that follows, the technique for generating widgets is applied to electronic-design-automation (EDA) software as an illustrative example. However, this technique may be used in conjunction with a wide variety of software, including: software applications, software development tools, firmware, operating systems and/or software testing tools.

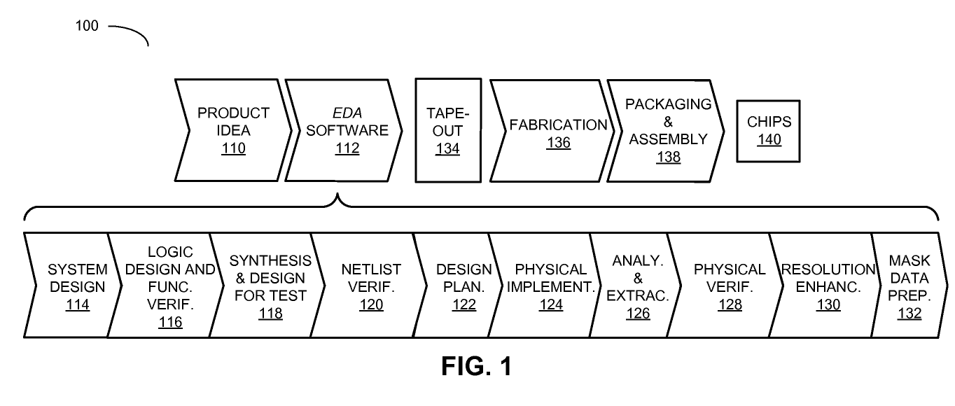

We now describe embodiments of design and fabrication of integrated circuits or chips. FIG. 1 presents a flowchart 100 illustrating the various operations in the design and fabrication of an integrated circuit. This process starts with the generation of a product idea (110), which is realized during a design process that uses EDA software (112). When the design is finalized, it can be taped-out (134). After tape-out, a semiconductor die is fabricated (136) and packaging and assembly processes (138) are performed, which ultimately result in finished chips (140).

Note that the design process that uses EDA software (112) includes operations 114-132, which are described below. This design flow description is for illustration purposes only. In particular, this description is not meant to limit the present disclosure. For example, an actual integrated circuit design may require a designer to perform the design operations in a different sequence than the sequence described herein.

During system design (114), designers describe the functionality to implement. They can also perform what-if planning to refine the functionality and to check costs. Note that hardware-software architecture partitioning can occur at this stage. Exemplary EDA software products from Synopsys, Inc. of Mountain View, Calif. that can be used at this stage include: Model Architect®, Saber®, System Studio®, and Designware® products.

Then, during logic design and functional verification (116), VHDL or Verilog code for modules in the circuit is written and the design is checked for functional accuracy. More specifically, the design is checked to ensure that it produces the correct outputs. Exemplary EDA software products from Synopsys, Inc. of Mountain View, Calif. that can be used at this stage include: VCS®, Vera®, Designware®, Magellan®, Formality®, ESP® and Leda® products.

Next, during synthesis and design for test (118), VHDL/Verilog is translated to a netlist. This netlist can be optimized for the target technology. Additionally, tests can be designed and implemented to check the finished chips. Exemplary EDA software products from Synopsys, Inc. of Mountain View, Calif. that can be used at this stage include: Design Compiler®, Physical Compiler®, Test Compiler®, Power Compiler®, FPGA Compiler®, Tetramax®, and Designware® products.

Moreover, during netlist verification (120), the netlist is checked for compliance with timing constraints and for correspondence with the VHDL/Verilog source code. Exemplary EDA software products from Synopsys, Inc. of Mountain View, Calif. that can be used at this stage include: Formality®, Primetime®, and VCS® products.

Furthermore, during design planning (122), an overall floor plan for the chip is constructed and analyzed for timing and top-level routing. Exemplary EDA software products from Synopsys, Inc. of Mountain View, Calif. that can be used at this stage include: Astro® and IC Compiler® products.

Additionally, during physical implementation (124), the placement (positioning of circuit elements) and routing (connection of the same) occurs. Exemplary EDA software products from Synopsys, Inc. of Mountain View, Calif. that can be used at this stage include: the Astro® and IC Compiler® products.

Then, during analysis and extraction (126), the circuit function is verified at a transistor level, which permits refinement. Exemplary EDA software products from Synopsys, Inc. of Mountain View, Calif. that can be used at this stage include: Astrorail®, Primerail®, Primetime®, and Star RC/XT® products.

Next, during physical verification (128), the design is checked to ensure correctness for: manufacturing, electrical issues, lithographic issues, and circuitry. Exemplary EDA software products from Synopsys, Inc. of Mountain View, Calif. that can be used at this stage include the Hercules® product.

Moreover, during resolution enhancement (130), geometric manipulations of the layout are performed to improve manufacturability of the design. Exemplary EDA software products from Synopsys, Inc. of Mountain View, Calif. that can be used at this stage include: Proteus®, Proteus®AF, and PSMGED® products.

Additionally, during mask-data preparation (132), the ‘tape-out’ data for production of masks to produce finished chips is provided. Exemplary EDA software products from Synopsys, Inc. of Mountain View, Calif. that can be used at this stage include the Cats® family of products.

Embodiments of the present disclosure can be used during one or more of the above-described stages. Specifically, in some embodiments the present disclosure can be used in EDA software 112, which may provide a custom schematic editor and simulation environment.

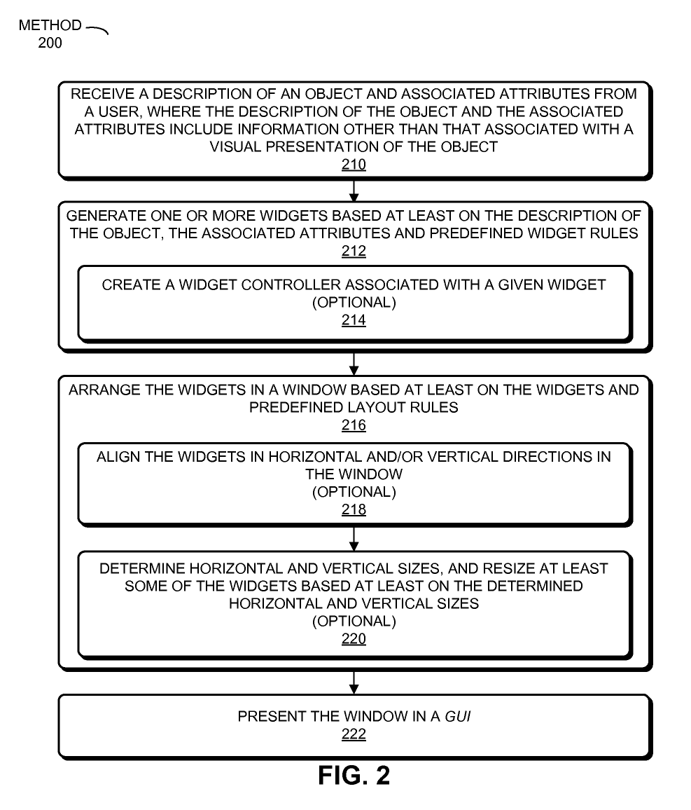

We now describe embodiments of a technique for presenting a window. FIG. 2 presents a flowchart illustrating a method 200 for presenting a window in a GUI, which may be performed by a computer system that executes computer software. During operation, the computer system receives a description of an object and associated attributes from a user (operation 210), where the description of the object and the associated attributes include information other than that associated with a visual presentation of the object (i.e., the user may specify the data model (such as types, restrictions, etc) and very little about the user interface). Note that the description may include restrictions on how the attributes may be manipulated, such as: a restriction on a range of possible values, valid discrete values and/or whether it is read-only. Then, the computer system generates one or more widgets (i.e., GUI elements) based at least on the description of the object, the associated attributes and predefined widget rules (operation 212), where the widgets include different types of widgets. Next, the computer system arranges the widgets in the window based at least on the widgets and predefined layout rules (operation 216), and presents the window in the GUI (operation 222).

In some embodiments, a given object (such as a data object) has an associated widget builder that determines the appropriate graphical representation for this type of data given system constraints and GUI guidelines. The widget builder may also update the data object based on user input in the GUI or when the data object itself is modified and expresses constraints on the sizing nature of the GUI. Moreover, the window (or the container) may use this information to adjust the layout. Note that both types and widget builders may be added to the computer system without modifying the computer system.

Furthermore, generating the given widget may optionally involve creating a widget controller that is associated with the given widget (operation 214). This widget controller may dynamically update the associated attributes based at least on changes, in the window, to a subset of the attributes associated with the given widget. Additionally, the widget controller may dynamically update the given widget in the window based at least on changes to one or more of the associated attributes. Note that the dynamic updates may occur after compiling of computer software that includes instructions associated with at least some the above-described operations. Alternatively or additionally, the dynamic updates may occur during execution of the computer software. Thus, the updates may involve runtime logic that executes when the computer software is running.

In some embodiments, the widget builder is bypassed by the computer software if a graphical representation is not wanted, such as when running a batch process. In this use model, the object and its attribute may be manipulated directly by the batch process rather than user input.

In some embodiments, arranging the widgets in the window involves aligning the widgets in a vertical direction in the window (operation 218). For example, the widgets may be aligned in one or more columns in the window. Alternatively or additionally, arranging the widgets in the window may involve: determining a horizontal size and a vertical size of the window (operation 220); and resizing at least some of the widgets based at least on the determined horizontal size and the determined vertical size (operation 220). Note that determining the horizontal size and the vertical size, and resizing at least some of the widgets may be performed dynamically based on changes to the associated attributes during execution of the computer software, thereby dynamically resizing the window.

For example, arranging the widgets in the window may adhere to a set of rules designed to provide an attractive and intuitive layout without the user specifying positions or expansion policy. Thus, the user may not need to specify how to: align the widget with other widgets, determine horizontal and vertical size, determine whether widgets expand horizontally or vertically as a container is expanded, and/or determine these properties for the container based at least on the widgets it contains.

Note that, when an automatic layout is sub-optimal, based on a user-specified manual override of the default layout, the computer system may arrange widgets in groups, labeled groups, and multiple columns with or without widget-to-widget justification. Furthermore, the widget arrangements may not adversely impact the benefits of automatic layout, such as: alignment, horizontal and vertical sizes, and/or expanding properties.

Furthermore, the predefined widget rules and the predefined layout rules may be different than the description of the object and the associated attributes. Additionally, the predefined widget rules and the predefined layout rules may not be provided by the user. In this way, the user may focus on the high-level aspects of what is to be presented in the GUI, instead of worrying about how to translate this information into a corresponding visual presentation.

In some embodiments, the generated widgets include predefined function icons if the object is associated with an executable procedure in the computer software. Furthermore, after the user activates one of the function icons, the executable procedure may perform a computation based at least on inputs, associated with the widgets, which are specified or provided by the user using the window.

Note that associated attributes may include constraints on the inputs. Consequently, the computer system may perform a self-check of an input associated with the given widget using one or more of the constraints. If the input violates at least one of the constraints, the computer system may change a visual presentation of the given widget, thereby alerting a user that there is an error condition.

In some embodiments of method 200 there are additional or fewer operations. Moreover, the order of the operations may be changed and/or two or more operations may be combined into a single operation.

We now describe embodiments of a widget and a GUI that includes the window. Typically, GUIs are divided into: a model, a view and a controller. The model contains the underlying data being displayed or entered in a window, e.g., a library (FTK), a cell (NMOS4), a view (such as a symbol). Furthermore, the view may include widgets, and the controller may synchronize the two, and may handle view interactions.

The GUI framework described herein may provide runtime, dynamic typed objects with notification. In this GUI framework, the objects and containers may communicate with each other in order to eliminate most of the controller from the client code. Furthermore, in the GUI framework, view objects may be at a higher level than in existing widget tool kits (e.g., cellview inputs rather than text-entry widgets), which may increase the level of application-wide consistency, and may move any code complexity from the individual window to the infrastructure. Similarly, the GUI framework may include a higher-level layout engine, thereby providing a geometry manager or layout (which is typically a difficult concept in GUI design).

As noted previously, using a widget tool kit associated with the GUI framework, a user may define one or more disconnected objects (including a description of the types of things the user wants to do and the associated attributes). For example, a given object may include: a dialog box to receive text from a user, a Boolean check box, and/or mutually exclusive elements, such as radio buttons or a combo box. However, the information provided by the user may not have anything to do with the visual presentation in the GUI (e.g., the description and the attributes may include high-level non-graphical information).

Note that separate widget builders for different types of disconnected objects may subsequently generate the widgets using the object descriptions and the associated attributes, and the layout engine may arrange the widgets in the window for presentation in the GUI. In particular, predefined widget rules may specify how each attribute is to be displayed (for example, text may be displayed as a line edit, and a combo box may be displayed as a drop-down menu). Using object introspection (a language capability in which it is possible to walk an object representation, such as the object description, without knowing its type), a widget builder for a type of predefined window may be selected based on an arbitrary number of attributes. This widget builder may read or walk the attribute tree, and may use the predefined widget rules to build a widget (and a corresponding widget controller for this widget) based on the attributes. For example, the user may provide an abstract concept of a label for different types of user inputs. Then, the appropriate widget builder(s) and the layout engine may generate a check box with the label to the right and selectable options to the left, or a text input with the label to the left, followed by a colon and a text-input field.

Thus, there is a loose coupling of the model (i.e., the data which is presented and modified by a GUI, which in this framework includes the widgets) and the view/presentation. Users can define an abstract object (which has an ‘internal’ presentation of what the user wants), as opposed to the widgets or the window, which are generated on the fly/dynamically (i.e., the software can infer what the user means).

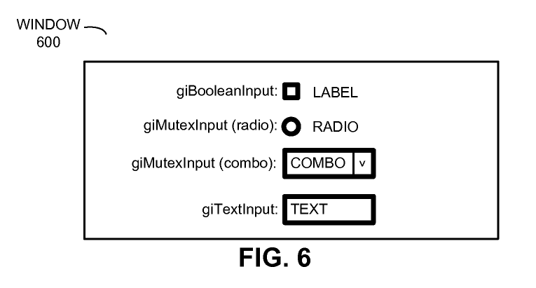

By ensuring that the details of how the actual widgets are constructed are hidden from the user, this approach can provide consistency while remaining flexible/configurable. For example, a widget builder may determine the default size of a widget and whether it stretches, etc. The layout engine may use this information to dynamically determine whether widgets should stretch, where the widget label goes, etc. Additionally, the user software code can interact with a disconnected object by changing its attributes, and the corresponding widget builder(s) may monitor these changes and updates to the widget, and vice versa (i.e., the widget controller(s) may maintain/synchronize the object description and the associated attributes with the widget). This capability can be used to provide higher-level functionality, such as the handling of an invalid input, which may keep an executable procedure from executing. (A window with an invalid input is described further below with reference to FIG. 6.)

This GUI framework may provide standard components for building interfaces using programming languages such as C++ or Tcl. Additionally, the object representation may be expressed in a structural format, such as eXtensible Markup Language (XML), rather than a procedural language, such as C++ or Tcl. Furthermore, by increasing the amount of common infrastructure, less code may be written for each window, and more features may be implemented generically. In some embodiments, a window with reasonable layout and proper (re-)sizing may be defined using one line of code per widget, even for complicated widget types.

Note that the architecture of the GUI framework may be divided into: a core, which includes the basic, runtime core objects that are used to represent the model as well as the view objects; a view, which is the dynamically constructed GUI based on the non-graphical objects; user logic that includes execution procedures and handlers for changes to the model data; and a script language that accesses the GUI framework via object introspection.

As noted previously, and in contrast with existing GUI designs, in some embodiments the objects are not actual graphical objects. Instead, the GUI may be generated dynamically from non-graphical objects representing the widget attributes. To the client, there is little difference because both result in a window (such as a dialog box). However, this approach may allow: an object description to be used to dynamically generate different types of widgets (e.g., tabbed versus notebook layouts, or radio buttons versus a combo box); from the user perspective, layout controls and complexity can be handled in a ‘black box’; and the object can be used without generating the widgets (i.e., the software application can execute even when the GUI is not operating).

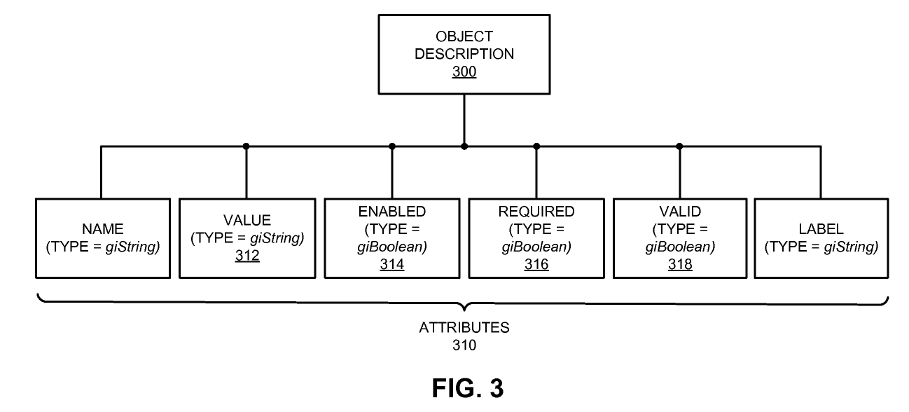

Widgets can be defined using core objects in the GUI framework. FIG. 3 presents a drawing illustrating attributes 310 associated with an object description 300 of a widget. This object takes a text-input object as an input, and produces a Qt widget. Note that attributes 310 (e.g., enabled 314 or required 316) are named child objects.

Because the attributes are represented using GUI-framework values, the full list of attributes can be retrieved and queried dynamically by, for example, a GUI design application. Furthermore, the attributes natively support notification, which allows the corresponding widget to dynamically update to reflect the current attribute value.

Note that a widget builder is defined for the text-input object shown in FIG. 3. Furthermore, a widget controller that updates the Qt widget when the GUI-framework objects are modified, and vice versa, is also defined. In addition, client code may listen to the modification(s) to the GUI-framework object via the same notification system.

For example, suppose a user types “net<0”7>” into the text-input field of a window (such as a dialog box), when he meant to type “net<0:7>.” The Qt widget may notify the black-box widget controller, which updates value 312. Furthermore, a software-application listener, tied to this particular input, may also be notified. If the user code is notified of the change to value 312, and decides that the input is invalid, it may set value 312 to false. This notifies the black-box widget controller, which may change the foreground color of the Qt widget to red (as shown below in FIG. 6).

Note that the dialog box may also register as a listener to the valid attributes it contains. When object description 300 is changed, the dialog box may determine that at least one required input (such as required 316) is invalid. Consequently, it may disable the “OK/Apply” button in a window that includes the Qt widget (thereby, preventing execution of an executable procedure in the software application), and may inform the user that the executable procedure cannot be performed because the input (identified by its label property) is invalid.

In another example, consider a cellview-input object, which has the same basic sub-objects as those for the text-input object. However, there may be additional input restrictions. Furthermore, the widget builder for this object may use three separate text-input objects to represent the library, cell and the view components. Additionally, instead of using a string object for value 312, a cellview object may be used. When modified, a listener may fire, which splits the triplet into individual values that are sent to: the library input, the cell input and the view input, thereby updating the view. Note that the opposite is also true, i.e., when any of the widgets is changed, the library, cell and view objects may be modified. These changes may trigger the listener for the cellview-input object, which updates value 312. The advantage here is that the caller only needs to create a single widget, and the output from that widget is usable with other Tcl application-programming interfaces in a software application.

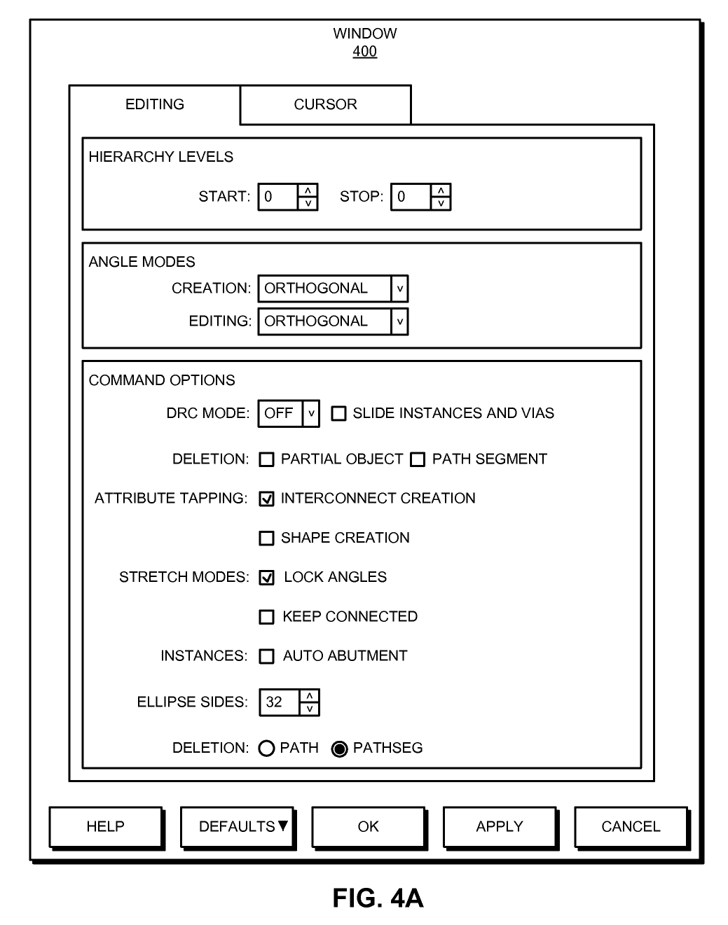

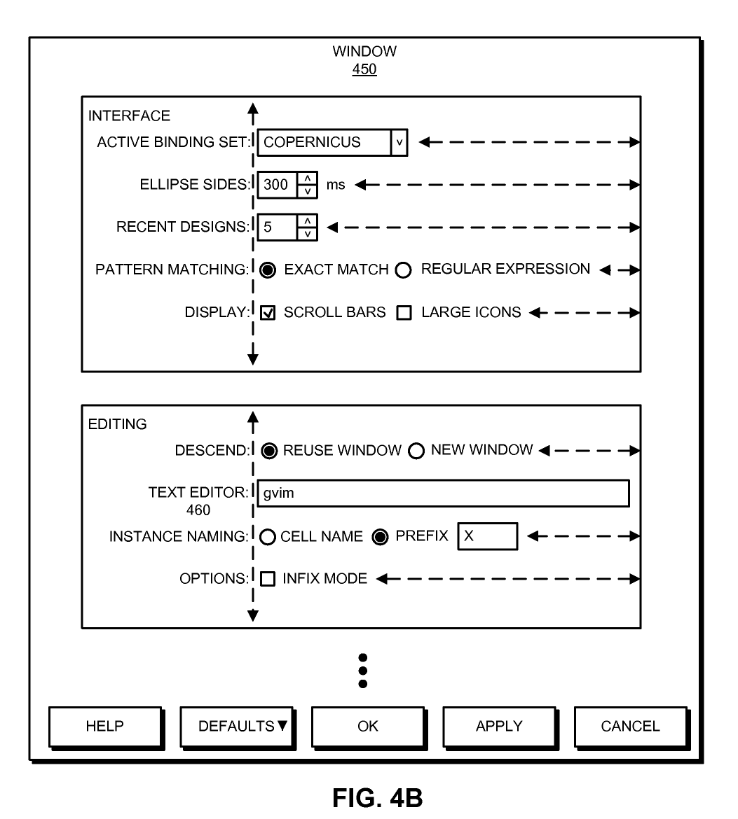

As shown in FIG. 4A, which presents a drawing illustrating a window 400 that includes multiple widgets, based on instructions from the layout engine, dialog boxes and grouping widgets (such as group boxes and frames) may lay out component widgets in a grid pattern. Note that the labels appear to the left, and the widgets are to the right. In addition, the labels are right/top aligned.

In general, there are two types of widgets: labeled widgets and unlabeled widgets. Labeled widgets may include: check boxes, line edits, radio buttons and combo boxes. When a labeled widget is added to the GUI-framework layout, a left column may be created with the title of the added labeled widget without any additional user action. Note that the containers offer the ability to disable the label for use with larger widgets, such as text-block inputs. In addition, the label column may only be shown when at least one contained widget has a non-empty label. Unlabeled widgets include: group boxes, layouts (horizontal or vertical) and LCV selectors. These widgets may fill the space of the left/label column.

In some embodiments, sibling containers synchronize the width of their odd-numbered columns. This is shown in FIG. 4B, which presents a drawing illustrating a window 450 that includes multiple widgets. In this window, the horizontal widths of the widgets are adjusted (as indicated by the horizontal dashed lines) so that the widgets are aligned relative to each other (as indicated by the horizontal dashed line).

Note that a dialog box may be marked as having fixed horizontal and/or vertical sizes when none of its contained widgets resize in either of those directions. Alternatively, whether the dialog has a fixed size may be determined by its contents rather than being explicitly set by the user. In GUI 450, the dialog box may resize horizontally because the text-input field, Text Editor 460, is marked as ‘expanding.’ If this field had a fixed size, the size of the dialog box would also be fixed. When a dialog expands horizontally, all expanding widgets expand in that direction. Whether or not a widget expands is defined in its associated attributes.

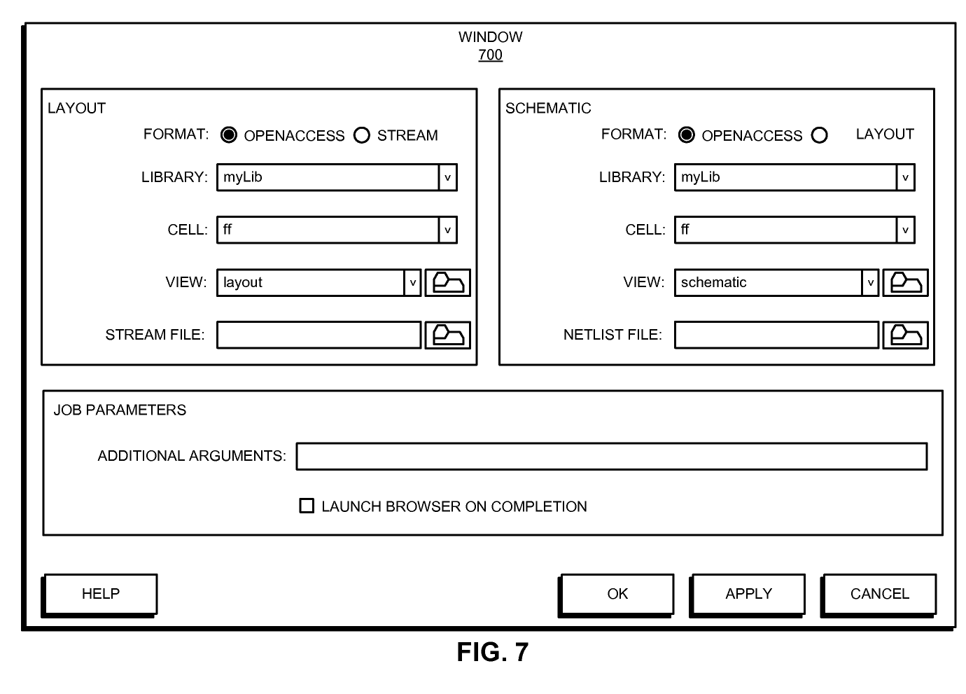

Furthermore, the GUI framework may create a basic widget layout based at least on the order widgets are added to the parent group. By default, one widget is created per row. While multiple widgets may be placed in a given row, they may not be aligned with respect to other widgets. This form of layout may be sufficient for standard dialog boxes, where each row specifies a distinct input, as well as more complicated dialog boxes (such as the example described below with reference to FIG. 7).

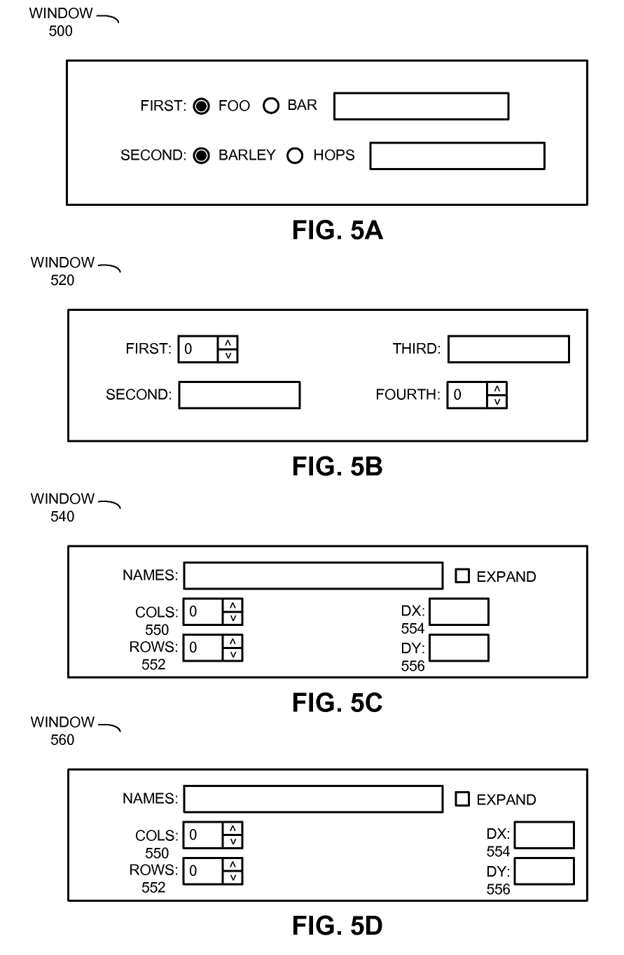

FIG. 5A presents a drawing illustrating a window 500 that includes multiple widgets. This GUI reflects the Tcl commands in the pseudo-code shown in Table 1.

TABLE 1
set d [gi::createDialog exLayout -title “Layout Examples”]
set m [gi::createMutexInput -parent $d -enum {Foo Bar} -label “First”]
set 1 [gi::createTextInput -parent $d -state disabled]
gi::layout $1 -rightOf $m
set m [gi::createMutexInput -parent $d -enum {Barley Hops} -label
“Second”]
set 1 [gi::createTextInput -parent $d -state disabled]
gi::layout $1 -right $m

Note that multi-column layouts may divide the space within a wide dialog box more efficiently. Multi-column layouts may also be created in the GUI framework using the ‘-align’ argument (or attribute) to the ‘gi::layout’ command. This is shown in FIG. 5B, which presents a drawing illustrating a window 520 that includes multiple widgets, and by the corresponding Tcl commands in the pseudo-code shown in Table 2.

TABLE 2

set d [gi::createDialog exLayout -title “Layout Examples”]
set w1 [gi::createNumberInput -parent $d -label “First”]
set w2 [gi::createTextInput -parent $d -label “Second”]
set w3 [gi::createTextInput -parent $d -label “Third”]
set w4 [gi::createNumberInput -parent $d -label “Fourth”]
gi::layout $w3 -rightOf $w1
gi::layout $w4 -rightOf $w2 -align $w3

In some embodiments, all the widgets in a group do not fall within the same column alignment. For example, as shown in FIG. 5C (and by the corresponding pseudo-code in Table 3), which presents a drawing illustrating a window 540 that includes multiple widgets, the first row may contain multiple widgets that are not aligned with the other widgets.

TABLE 3

set d [gi::createDialog exLayout -title “Layout Examples”]
set n [gi::createTextInput -parent $d -label “Names” -width 0]
set e [gi::createBooleanInput -parent $d -label “Expand”]
gi::layout $e -rightOf $n
set c [gi::createNumberInput -label “Cols” -parent $d]
set r [gi::createNumberInput -label “Rows” -parent $d]
set dx [gi::createNumberInput -label “DX” -type float -parent $d]
set dx [gi::createNumberInput -label “DY” -type float -parent $d]
gi::layout $dx -rightOf $c
gi::layout $dy -rightOf $r -align $dx

In FIG. 5C, the first row may be considered to be ‘column-spanning’ because it spans the space allotted to the first column (Cols 550 and Rows 552) and the second column (DX 554 and DY 556). More generally, in the GUI-framework layout engine, all rows may be column-spanning until aligned with a widget in another row. Instead, when the user specifies the attribute argument ‘-align,’ the layout engine may be instructed to push the X coordinate of a widget further to the right until it aligns with the X coordinate of another widget. Because this is a commutative relationship, depending on the label and widget geometry it may actually be the X coordinate of the other widget that is pushed. In fact, there may be other widgets in the same constraint that also affect this relationship. Note that the order of creation may not matter, i.e., both the origin of the widget and the label may be aligned.

Note that each call to ‘gi::layout’ may remove all previous layout knowledge for a widget and recreate it with the new arguments. Furthermore, a widget may be inserted in a row before another with the ‘-before’ and ‘-after’ attribute arguments. Additionally, this layout constraint may not affect the widget's size, which is determined internally based at least on the widget type, and may sometimes be altered by widget attributes, such as the width attribute of a text-input widget.

Furthermore, note that each call to ‘gi::layout’ may establish a constraint between two widgets in a dialog, a window or another container. This relationship may be honored by the computer system by altering its automatic layout based at least on the constraint. However, the widgets may not need to be modified or moved, and the constraint can be defined after creation.

In some embodiments, the user may choose to justify (left, right or center) widgets within a column (note that by default, widgets may be left-justified). If multiple widgets within a column have different justifications, their labels may not align. However, those with the same justification may be properly aligned. For example, FIG. 5D presents a drawing illustrating a window 560 that includes multiple widgets, and Table 4 provides the corresponding pseudo-code. This GUI represents the example shown in FIG. 5C when the inputs DX 554 and DY 556 are right justified.

TABLE 4

set d [gi::createDialog exLayout -title “Layout Examples”]
set n [gi::createTextInput -parent $d -label “Names” -width 0]
set e [gi::createBooleanInput -parent $d -label “Expand”]
gi::layout $e -rightOf $n
set c [gi::createNumberInput -label “Cols” -parent $d]
set r [gi::createNumberInput -label “Rows” -parent $d]
set dx [gi::createNumberInput -label “DX” -type float -parent $d]
set dx [gi::createNumberInput -label “DY” -type float -parent $d]
gi::layout $dx -rightOf $c -justify right
gi::layout $dy -rightOf $r -justify right -align $dx

Inputs to the GUI-framework widgets may have a valid 318 (FIG. 3) attribute, which is used to indicate that an input currently contains an invalid input. Note that the input may be validated either internally by the input widget or externally via the interface author during a value-changed event. In some cases, both operations may happen, in which case the widget may self-validate before emitting the value-changed event.

Validation (and, thus, value-changed callbacks) may occur when a widget ‘loses focus’ or is not in a ‘focused’ state (which is described further below). This encourages widgets to support self-validation wherever possible. For example, a user may modify a widget. In response, a widget controller may modify the attribute value associated with the widget. This value modification may trigger user code, which may find that the value is incomplete or invalid. Consequently, the user code may set the widget's valid attribute to false. Then, the valid modification triggers GUI-framework dialog code that updates the valid state of the window.

In some embodiments, widgets are initially in an invalid state, for example, if an associated preference value is invalid, or if an input is ‘required’ but is initially empty. Widgets in an invalid state may be annotated with a red border. This is shown in FIG. 6, which presents a drawing illustrating a window 600 that includes multiple widgets.

In executable dialog boxes (i.e., dialog boxes associated with an executable procedure that uses the inputs to perform an operation), widgets with invalid inputs may not be immediately annotated. Instead, these widgets may appear without a red border until the “OK/Apply button” is pressed by the user, at which time all widgets in the invalid state are highlighted with a red border (which is indicated by the thicker lines in FIG. 6). Once the “OK/Apply button” is pressed, the widget responds to any valid input changes by immediately clearing the highlighted state of the widget unless the widget has a so-called ‘focused’ state. In particular, in order to avoid distracting users while they are modifying an input, a widget having a ‘focused’ state may temporarily appear as if it is in the valid state. For interactive commands, when the user moves the mouse out of the dialog box and over the canvas, the widgets with invalid inputs may then be annotated. However, in non-executable dialog boxes, and within main windows or other containers, the annotation may happen immediately on each change, which matches the use model of executable dialog boxes directly after the “OK/Apply” button is pressed. Note that disabled widgets may not be considered as having invalid inputs, and, as such, may not be annotated.

If any widgets have invalid inputs when the “OK/Apply” button is pressed, the dialog box may continue to be displayed, and the execution procedure associated with the dialog box may not be called. Moreover, the first invalid widget may have a ‘focused’ state. Note that if the first invalid widget appears on another tab or within a collapsed group box, the tab is shown or the group box is expanded in order to make this widget visible. At this time, an error message may be printed to the console explaining the error, such as: “Error: The requested action could not be completed because one or more inputs are incomplete or invalid.”

In some embodiments, fields with invalid inputs are annotated during the execution procedure associated with a dialog box. However, in these embodiments the GUI framework may not know that the client code aborted the operation unless the dialog author returns an error in the execution procedure. Therefore, the dialog author may return an error message (for example, via a Tcl ‘error’ command) that is similar to the default message in the previous paragraph.

Note that some widgets may also have required inputs. For example, the GUI-framework input widgets may have a required attribute that is used to indicate inputs which must be non-empty in order for the dialog box to execute. This attribute enables a validation feature in these widgets, which sets the widget to a valid state when the input is non-empty, or an invalid state when empty. Because this may happen before triggering value-changed event(s), the client code may further restrict what is considered to be an invalid input.

In some embodiments, the widget builder may add commonly used buttons to the button bar in a window, and may allow additional buttons to be defined. These buttons may be used in dialog box use models. For example, if an execution procedure is provided in the object description, the dialog box may be considered executable and may include an “OK” button, and optionally an “Apply” button in the button bar. If defined, the “OK” button may trigger both execute and close procedures.

Alternatively or additionally, if the attributes associated with at least one widget include an associated preference, a “Defaults” button may be included in the window, along with a pull-down menu that is populated based on the preference scope. Similarly, the user may also provide a defaults procedure, which is called immediately after restoring any preferences used in the dialog box to their default values. Note that, if no widgets in a window are associated with preferences, but the user provides a defaults procedure, a “Defaults” button may be included in the window, but without the pull-down menu.

In general, the “Cancel” button may be included in windows. In addition, the dialog author may include additional buttons that are placed to the immediate left of the “Cancel” button.

A complicated dialog-box example is shown in FIG. 7, which presents a drawing illustrating a window 700 that includes multiple widgets, along with the corresponding pseudo-code in Table 5. In the ‘set’ command, the user constructs object ‘Launch LVS,’ including attributes such as: a name, a title and that it is an executable procedure. Then, the user creates several groups, each of which is a hierarchy for inputs, and which have attributes such as: a name (e.g., ‘layout’), a parent dialog and a layout.

Note that there are three inputs: ‘MutexInput,’ ‘CellViewInput,’ and ‘FileInput.’ Each of these inputs has expressed constraints. For example, MutexInput can be either ‘OpenAccess’ or ‘Stream.’ By default, the current value is OpenAccess. Thus, the attributes can define a type of command that a corresponding widget can take. Furthermore, the type of widget (such as a radio button) may be inferred by the software that creates the widgets.

In addition, note that the CreateViewInput is required (‘requiredExisting’ is ‘true’), so if it is not defined, then the corresponding widget is in the invalid state. Moreover, FileInput is a stream value (i.e., a prompt that describes what the user should provide), and ‘fileMasks’ is a constraint.

This window resizes in the horizontal direction but not the vertical direction. In particular, the dialog-box size evenly distributes the widths of: the library inputs, the layout and schematic size, the initial organization, and the job parameters. For example, the command ‘layout $s-rightOf $1 ’ is a set of constraints on the side-by-side spatial layout and the alignment of specific fields.

TABLE 5
# Construct a Launch LVS dialog
# @param[in] w Parent window for the new dialog

# @return Launch LVS giDialog object
proc build {w} {

set d [gi::createDialog pvLaunchLVS -parent $w \

-title “Launch LVS” \
-execProc [namespace current]::exec]

# Layout group
set 1 [gi::createGroup layout -parent $d -label Layout]
gi::createMutexInput layoutFormat -parent $1 \

-label Format -enum {OpenAccess Stream} -value OpenAccess

dm::createCellViewInput layoutCellView -parent $1 \

-required true -requireExisting true

gi::createFileInput layoutGDSFile -parent $1 \

-label “Stream File” -prompt “Select an Stream File” \
-fileType file -fileMasks {“GDS Stream (*.gds)”} \
-mode select -enabled false -required true

# Schematic group
set s [gi::createGroup schematic -parent $d -label Schematic]
gi::createMutexInput schFormat -parent $s \

-label Format -enum {OpenAccess Netlist} -value OpenAccess

dm::createCellViewInput schCellView -parent $s \

-required true -requireExisting true

gi::createFileInput schNetlist -parent $s \

-label “Netlist File” -prompt “Select an HSPICE Netlist” \
-fileType file -fileMasks {“HSPICE Netlist (*.hspice)”} \
-mode select -enabled false -required true

# Layout the Layout and Schematic groups side-by-side
gi::layout $s -rightOf $1
# Job parameters group
set g [gi::createGroup params -parent $d \

-label “Job Parameters”]

gi::createTextInput arguments -parent $g \

-label “Additional Arguments”

gi::createBooleanInput launchBrowser -parent $g \

-label “Launch Browser on Completion” \
-value false

}

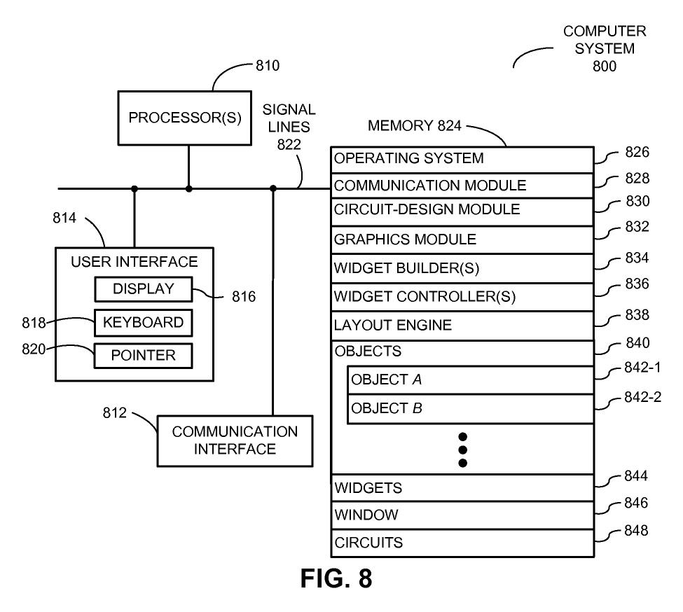

We now describe embodiments of a computer system that selects an object. FIG. 8 presents a block diagram illustrating a computer system 800 that performs method 200 (FIG. 2). Computer system 800 includes: one or more processors 810, a communication interface 812, a user interface 814, and one or more signal lines 822 coupling these components together. Note that the one or more processing units 810 may support parallel processing and/or multi-threaded operation, the communication interface 812 may have a persistent communication connection, and the one or more signal lines 822 may constitute a communication bus. Moreover, the user interface 814 may include: a display 816, a keyboard 818, and/or a pointer 820, such as a mouse.

Memory 824 in computer system 800 may include volatile memory and/or non-volatile memory. More specifically, memory 824 may include: ROM, RAM, EPROM, EEPROM, flash, one or more smart cards, one or more magnetic disc storage devices, and/or one or more optical storage devices. Memory 824 may store an operating system 826 that includes procedures (or a set of instructions) for handling various basic system services for performing hardware-dependent tasks. Memory 824 may also store procedures (or a set of instructions) in a communication module 828. These communication procedures may be used for communicating with one or more computers and/or servers, including computers and/or servers that are remotely located with respect to computer system 800.

Memory 824 may also include multiple program modules (or sets of instructions), including: circuit-design module 830 (or a set of instructions), graphics module 832 (or a set of instructions), one or more widget builder(s) 834 (or a set of instructions), one or more widget controller(s) 836 (or a set of instructions), and/or a layout engine 838 (or a set of instructions). Note that one or more of these program modules (or sets of instructions) may constitute a computer-program mechanism.

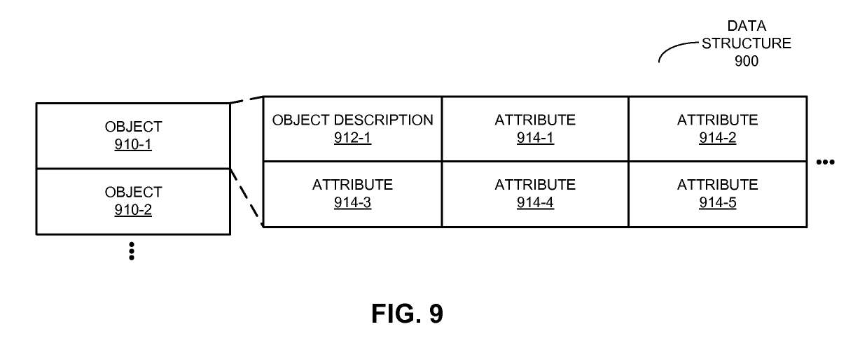

A user may provide high-level definitions of the functionality associated with one or more (non-graphical) objects 840, such as object A 842-1 and object B 842-2. As shown in FIG. 9 below, the description of each of these objects may include an object description and associated attributes. These attributes may include runtime core objects in graphics module 832 that represent the model and the view objects, such as widgets 844.

Graphics module 832, which provides the GUI framework, may dynamically interpret the information provided for objects 840 to generate widgets 844. These widgets may be displayed in a window 846 in a GUI on display 816 during execution of circuit-design module 830 (which the user may use to view or modify designs for one or more circuits 848). In particular, graphics module 832 may determine one or more widget types from the information provided for objects 840 via object introspection. For example, if there are more than three inputs in a given widget, a radio box may be used; otherwise, a combo box may be used. Then, the corresponding widget builders 834 may generate widgets 844, and layout engine 838 may arrange widgets 834 in window 846 (including aligning widgets 844 and resizing them as needed). In general, there may be multiple widgets generated based on a given object.

When generating widgets 844, widget builders 834 may also create corresponding widget controllers 836. These widget controllers may maintain the synchronization of the model (i.e., the information in objects 840) and the view (i.e., widgets 844 and window 846) by responding to changes to either. Note that user code in a software application (such as circuit-design module 830) and/or associated with widgets 844 may also include user logic, which includes execution procedures and handlers for changes to the model data (e.g., objects 840).

In some embodiments, objects 840 facilitate execution of circuit-design module 830 even if graphics module 832 is disabled.

Instructions in the various modules in the memory 824 may be implemented in: a high-level procedural language, an object-oriented programming language, and/or in an assembly or machine language. Note that the programming language may be compiled or interpreted, e.g., configurable or configured, to be executed by the one or more processing units 810.

Computer system 800 may include a variety of devices, such as: a personal computer, a laptop computer, a server, a work station, a mainframe computer, and/or other device capable of manipulating computer-readable data.

Although computer system 800 is illustrated as having a number of discrete items, FIG. 8 is intended to be a functional description of the various features that may be present in computer system 800 rather than a structural schematic of the embodiments described herein. In practice, and as recognized by those of ordinary skill in the art, the functions of computer system 800 may be distributed over a large number of servers or computers, with various groups of the servers or computers performing particular subsets of the functions. Consequently, computer system 800 may be at one location or may be distributed across multiple locations, such as computing systems that communicate via a network (such as the Internet or an intranet).

In some embodiments, some or all of the functionality of computer system 800 may be implemented in one or more: application-specific integrated circuit (ASICs), field-programmable gate array (FPGAs), and/or one or more digital signal processors (DSPs). Note that the functionality of computer system 800 may be implemented more in hardware and less in software, or less in hardware and more in software, as is known in the art.

We now discuss embodiments of data structures that may be used in computer system 800. FIG. 9 presents a block diagram illustrating a data structure 900. This data structure may include one or more objects 910, which may correspond to one or more widgets. For example, object 910-1 may include: an object description 912-1, and multiple associated attributes 914.

In some embodiments, computer system 800 (FIG. 8) and/or data structure 900 include fewer or additional components. Moreover, two or more components may be combined into a single component and/or a position of one or more components may be changed.

The foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art. Additionally, the above disclosure is not intended to limit the present disclosure. The scope of the present disclosure is defined by the appended claims.

What is claimed is:

1. A computer-implemented method for presenting a window in a graphical user interface (GUI), comprising:
receiving, from a user, a description of an object and associated attributes, wherein the description of the object and the associated attributes include information other than that associated with a visual presentation of the object;
generating widgets based at least on the description of the object, the associated attributes and predefined widget rules, wherein the widgets include different types of widgets;
arranging the widgets in the window based at least on the widgets and predefined layout rules; and
presenting the window in the GUI.

2. The method of claim 1, wherein a given object has an associated widget builder that determines a graphical representation for an associated type of data based at least on system constraints and GUI guidelines.

3. The method of claim 1, wherein generating the given widget involves creating a widget controller that is associated with the given widget; and
wherein the widget controller dynamically updates the associated attributes based at least on changes, in the window, to a subset of the attributes associated with the given widget, and dynamically updates the given widget in the window based at least on changes to one or more of the associated attributes.

4. The method of claim 3, wherein the dynamic updates occur after compiling of computer software associated with the method.

5. The method of claim 3, wherein the dynamic updates occur during execution of computer software associated with the method.

6. The method of claim 1, wherein arranging the widgets in the window involves aligning the widgets in a vertical direction in the window.

7. The method of claim 1, wherein arranging the widgets in the window involves aligning the widgets in columns in the window.

8. The method of claim 1, wherein arranging the widgets in the window involves:
determining a horizontal size and a vertical size of the window; and
resizing at least some of the widgets based at least on the determined horizontal size and the determined vertical size.

9. The method of claim 8, wherein determining the horizontal size and the vertical size, and resizing at least some of the widgets is performed dynamically based on changes to the associated attributes during execution of computer software associated with the method, thereby dynamically resizing the window.

10. The method of claim 1, wherein the predefined widget rules and the predefined layout rules are different than the description of the object and the associated attributes.

11. The method of claim 1, wherein the predefined widget rules and the predefined layout rules are not provided by the user.

12. The method of claim 1, wherein the generated widgets include predefined function icons if the object is associated with an executable procedure in computer software, which is associated with the method; and
wherein, after the user activates one of the function icons, the executable procedure performs a computation based at least on inputs, associated with the widgets, which are specified or provided by the user using the window.

13. The method of claim 1, wherein the associated attributes include constraints on inputs, associated with the widgets, which are specified or provided by the user using the window; and
wherein the method further includes performing a self-check of an input associated with the given widget using one or more of the constraints.

14. The method of claim 13, wherein the method further includes changing a visual presentation of the given widget if the input violates at least one of the constraints.

15. A computer-program product for use in conjunction with a computer system, the computer-program product comprising a computer-readable storage medium and a computer-program mechanism embedded therein for presenting a window in a GUI, comprising:
instructions for receiving, from a user, a description of an object and associated attributes, wherein the description of the object and the associated attributes include information other than that associated with a visual presentation of the object;
instructions for generating widgets based at least on the description of the object, the associated attributes and predefined widget rules, wherein the widgets include different types of widgets;
instructions for arranging the widgets in the window based at least on the widgets and predefined layout rules; and
instructions for presenting the window in the GUI.

16. The computer-program product of claim 15, wherein a given object has an associated widget builder that determines a graphical representation for an associated type of data based at least on system constraints and GUI guidelines.

17. The computer-program product of claim 15, wherein generating the given widget involves creating a widget controller that is associated with the given widget; and
wherein the widget controller dynamically updates the associated attributes based at least on changes, in the window, to a subset of the attributes associated with the given widget, and dynamically updates the given widget in the window based at least on changes to one or more of the associated attributes.

18. The computer-program product of claim 15, wherein arranging the widgets in the window involves:
determining a horizontal size and a vertical size of the window; and
resizing at least some of the widgets based at least on the determined horizontal size and the determined vertical size.

19. The computer-program product of claim 18, wherein determining the horizontal size and the vertical size, and resizing at least some of the widgets is performed dynamically based on changes to the associated attributes during execution of the computer-program product, thereby dynamically resizing the window.

20. The computer-program product of claim 15, wherein the predefined widget rules and the predefined layout rules are not provided by the user.

21. The computer-program product of claim 15, wherein the associated attributes include constraints on inputs, associated with the widgets, which are specified or provided by the user using the window; and
wherein the computer-program mechanism further includes instructions for performing a self-check of an input associated with the given widget using one or more of the constraints.

22. The computer-program product of claim 21, wherein the computer-program mechanism further includes instructions for changing a visual presentation of the given widget if the input violates at least one of the constraints.

23. A computer system, comprising:
a processor;
memory; and
a program module, wherein the program module is stored in the memory and configured to be executed by the processor to present a window in a GUI, the program module including:
instructions for receiving, from a user, a description of an object and associated attributes, wherein the description of the object and the associated attributes include information other than that associated with a visual presentation of the object;
instructions for generating widgets based at least on the description of the object, the associated attributes and predefined widget rules, wherein the widgets include different types of widgets;
instructions for arranging the widgets in the window based at least on the widgets and predefined layout rules; and
instructions for presenting the window in the GUI.
